(19) United States
(12) Patent Application Publication
(10) Pub. No.: US 2012/0136498 A1
(43) Pub. Date: May 31, 2012

(54) RACK SERVER SYSTEM

(75) Inventors: Chih-Wei CHEN, TAIPEI CITY (TW); Hsiao-Fen LU, TAIPEI CITY (TW)

(73) Assignee: INVENTEC CORPORATION, TAIPEI CITY (TW)

(21) Appl. No.: 13/043,480

(22) Filed: Mar. 9, 2011

(30) Foreign Application Priority Data
Nov. 29, 2010 (CN) 201010572345.6

(51) Int. Cl. G06F 1/26

(52) U.S. Cl. 700/297

(57) ABSTRACT

A rack server system includes a plurality of servers, a plurality of cooling modules, a power supply device, and a monitoring management module. Each of the servers includes a sensor so that the sensor can provide the temperature information of each of the servers to the monitoring management module. The power supply device includes a plurality of power supply modules.

Furthermore, the monitoring management module includes a processor, a management network switch, and a peripheral control interface. The processor is operable to obtain a power consumption from each of the servers through the management network and a temperature information from the sensor. The processor is operable to turn on some of the power supply modules and control the cooling modules through the peripheral control interface based on a total power consumption of the servers and the is temperature information.

### RELATED APPLICATIONS

This application claims priority to China Application Serial Number 201010572345.6, filed Nov. 29, 2010, which is herein incorporated by reference.

### BACKGROUND

1. Field of Invention

The present invention relates to a server system, and more particularly to a rack server system.

2. Description of Related Art

During recent years, with the commercial and industrial development and the social advancement, a product provided accordingly is mainly directed to convenience, realness and economy, and thus a currently developed product becomes more advanced than before so as to make contributions to the society.

Generally, in a rack server, each server has a respective heat dissipation fan, and thus each server controls its heat dissipation fan through a respective temperature monitoring device. Therefore, each server system needs to be equipped with a set of heat dissipation fans, and a rotation speed of each heat dissipation fan is adjusted based on monitoring parameters of the server.

As mentioned above, the rack server cannot use a uniform heat dissipation control mechanism for each server therein, but a large number of fan sets need to be disposed. When a new heat dissipation apparatus (e.g. a water-cooled regulating valve) is added to the rack server, it is difficult to perform uniform management and control.

In view of the above, it is apparent that the existing manners are still inconvenient and defective and need to be further improved. In order to solve the above problems, people in the related arts make best efforts to search for a solution, but no appropriate manner is developed for so long. Therefore, it is one of the important research and development subjects at present and also an actual improvement objective in the current related arts to avoid the problem that a large number of fans need to be disposed because the heat dissipation control mechanisms of the rack server cannot be unified and the problem that it is difficult to perform uniform management and control when a new heat dissipation apparatus is added.

### SUMMARY

The present invention aims to provide a rack server system, so as to solve the problem that a large number of fans need to be disposed because heat dissipation control mechanisms of a rack server cannot be unified and the problem that it is difficult to perform uniform management and control when a new heat dissipation apparatus is added.

In order to achieve the above objective, a technical aspect of the present invention relates to a rack server system, which includes a plurality of servers, a plurality of cooling modules, a power supply device, and a monitoring management module. Each of the servers includes a sensor so that the sensor can provide temperature information of each of the servers.

Furthermore, the power supply device comprising a plurality of power supply modules, wherein each of the power supply modules is used to provide a constant power. The monitoring management module is communicatively connected with the servers and the cooling modules. The monitoring management module includes a processor, a management network switch and a peripheral control interface. The management network switch is used to provide a management network to connect the processor with each of the servers. The peripheral control interface connects the cooling modules and the power supply device to the processor. The processor obtains a power consumption from each of the servers and obtains the temperature information from the sensor of each of the servers through the management network, the processor decides to turn on some of the power supply modules through the peripheral control interface based on a total power consumption of the servers so that the power supply device provides a dynamic power, and the processor controls the cooling modules through the peripheral control interface based on the obtained temperature information.

According to one embodiment of the present invention, each of the cooling modules is a fan or a water-cooled apparatus.

According to another embodiment of the present invention, the monitoring management module further includes a memory which is used to store a comparison table of a temperature and a fan rotation speed. The processor looks up in the comparison table of the temperature and the fan rotation speed based on the obtained temperature information to obtain a fan rotation speed value, and the processor adjusts a rotation speed of the fans through the peripheral control interface based on the fan rotation speed value.

According to yet another embodiment of the present invention, the processor controls the rotation speed of the fans based on the fan rotation speed value so that the rotation speed of the fans is not lower than the fan rotation speed value.

According to still another embodiment of the present invention, the monitoring management module further includes a system network switch and a remote monitoring apparatus. The system network switch is communicatively connected with an external Ethernet, and the system network switch is used to provide a system network. The processor and each of the servers are connected to the remote monitoring apparatus through the system network.

According to yet another embodiment of the present invention, the remote monitoring apparatus is communicatively connected with the processor through the system network to obtain and display the temperature information and the power consumption of each of the servers, the turn-on or turn-off state of the power supply modules of the power supply device, and the rotation speed value of each of the fans.

According to still another embodiment of the present invention, the remote monitoring apparatus is used to set an upper limit of the power consumption of each of the servers.

According to yet another embodiment of the present invention, when knowing through the system network that any one of the servers, the power supply modules or the fans had a breakdown, the remote monitoring apparatus generates a corresponding alarm signal.

Thus, according to the technical contents of the present invention, the embodiments of the present invention provide a rack server system, so as to solve the problem that a large number of fans need to be disposed because heat dissipation control mechanisms of a rack server cannot be unified and the problem that it is difficult to perform uniform management and control when a new heat dissipation apparatus is added.

It is to be understood that both the foregoing general description and the following detailed description are by examples, and are intended to provide further explanation of the invention as claimed.

### BRIEF DESCRIPTION OF THE DRAWINGS

In order to make the foregoing as well as other aspects, features, advantages, and embodiments of the present invention more apparent, the accompanying drawings are described as follows:

FIG. 1 is a circuit block diagram of a rack server system according to an embodiment of the present invention.

### DETAILED DESCRIPTION

In order to make the description of the present invention more detailed and more comprehensive, various embodiments are described below with reference to the accompanying drawings, wherein like reference numerals refer to like elements throughout. However, the embodiments are not used to limit the scope of the present invention, and the description of the operation of a structure is not used to limit its performing sequence. Any apparatus with equivalent functions that is produced from a structure formed by a recombination of elements shall fall within the scope of the present invention. The drawings are only for illustration and are not made according to original dimensions. In addition, well-known elements and steps are not described in the embodiments, thereby avoiding undesired limits on the present invention.

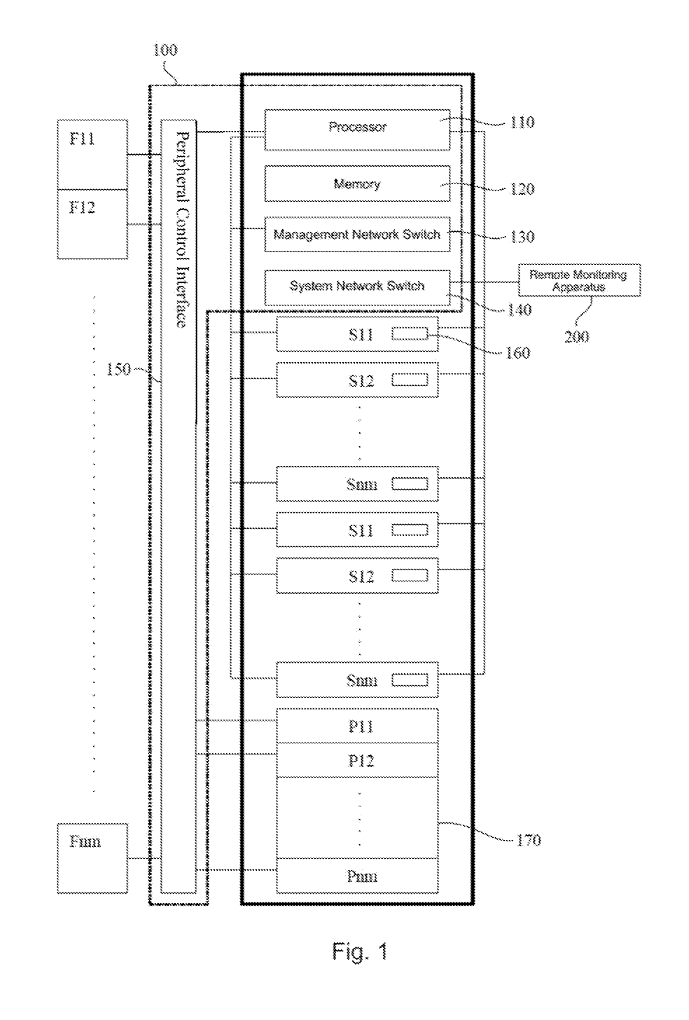

FIG. 1 is a circuit block diagram of a rack server system according to an embodiment of the present invention. As shown in FIG. 1, the rack server system includes a plurality of servers S11-Snm, a plurality of cooling modules F11-Fnm, a power supply device 170, and a monitoring management module 100. Each of the servers S11-Snm includes a sensor 160 for providing to temperature information of each of the servers S11-Snm.

The power supply device 170 includes a plurality of power supply modules P11-Pnm, and each of the power supply modules P11-Pnm is used to provide a constant power (for example, each of the power supply modules can supply a power of 500 W). The monitoring management module 100 is used to uniformly control the cooling modules F11-Fnm based on the temperature information, and the monitoring management module 100 includes a processor 110, a management network switch 130 and a peripheral control interface 150.

In manufacturing, the processor 110 can be a processing apparatus such as x86, ARM or 8051, and the peripheral control interface 150 can adopt a technology such as RS232, RS485, LAN, IPMI, I2C or PMBus. However, these are not intended to limit the present invention, and people skilled in the art can selectively adopt an appropriate processing apparatus or appropriate technology according to actual demands without departing from the spirit or scope of the present invention.

Furthermore, the management network switch 130 is used to provide a management network for connecting the processor 110 with each of the servers S11-Snm. The peripheral control interface 150 connects the cooling modules F11-Fnm and the power supply device 170 to the processor 110. The processor 110 obtains power consumption from each of the servers and obtains the temperature information from the sensor 160 of each of the servers S11-Snm through the management network. The processor 110 decides to turn on some of the power supply modules P11-Pnm through the peripheral control interface based on a total power consumption of the servers S11-Snm , so that the power supply device 170 provides a dynamic power, and the processor 110 controls the cooling modules F11-Fnm through the peripheral control interface 150 based on the temperature information. In manufacturing, each of the cooling modules F11-Fnm can be a fan or a water-cooled apparatus.

In this embodiment, the monitoring management module 100 further includes a memory 120 which is used to store a comparison table of a temperature and a fan rotation speed. The processor 110 looks up in the comparison table of the temperature and the fan rotation speed based on the obtained temperature information to obtain a fan rotation speed value, and the processor 110 adjusts a rotation speed of the fans F11-Fnm through the peripheral control interface 150 based on the fan rotation speed value.

In particular, the processor 110 controls the rotation speed of the fans F11-Fnm based on the fan rotation speed value so that the rotation speed of the fans F11-Fnm is not lower than the fan rotation speed value.

According to the principle and spirit of the present invention, the processor 110 can dynamically turn on or off the power supply modules P11-Pnm based on the total power consumption of the servers S11-Snm to meet requirements for energy saving. For example, if one power supply module can supply a constant power of 500 W, the processor 110 can decide the number of power supply modules to be turned on based on the total power consumption. Therefore, the power provided by the power supply device 170 changes with the number of the turned-on power supply modules, and thus the power provided by the power supply device 170 is referred to as a dynamic power.

In particular, the processor 110 turns on some of the power supply modules P11-Pnm through the peripheral control interface 150.

In one embodiment of the present invention, the monitoring management module 100 further includes a system network switch 140 and a remote monitoring apparatus 200. The system network switch 140 is connected with an external Ethernet, and the system network switch 140 is used to provide a system network. The processor 110 and each of the servers S11-Snm are connected to the remote monitoring apparatus 200 (e.g. a computer loaded with a management program or software) through the system network.

Furthermore, the remote monitoring apparatus 200 is communicatively connected with the processor 110 through the system network to obtain and display the temperature information and the power consumption of each of the servers S11-Snm, a turn-on or turn-off state of the power supply modules P11-Pnm of the power supply device 170, and the rotation speed value of each of the fans F11-Fnm.

Then, after the remote monitoring apparatus 200 obtains the temperature information, the power consumption, the turn-on or turn-off state of the power supply modules P11-Pnm of the power supply device 170 and the fan rotation speed value, the remote monitoring apparatus 200 displays the temperature information, the power consumption, the turn-on or turn-off state of the power supply modules P11-Pnm of the power supply device 170 and the fan rotation speed value. In this embodiment, the remote monitoring apparatus 200 is loaded with a web-based software interface, so that a user can browse the temperature and the power consumption of each of the servers S11-Snm in the current rack server and the conditions of the power supply modules and the fans through the system network. However, it is not intended to limit the present invention, and people skilled in the art can selectively display more information of the rack server according to actual demands through a setting interface without departing from the spirit or scope of the present invention.

In an optional embodiment, the user may further use the setting interface to set related settings, e.g. setting an upper limit of the power consumption of each of the servers S11-Snm or setting a condition for sending an alarm.

For example, when knowing that any one of the servers S11-Snm, the power supply modules P11-Pnm or the fans F11-Fnm has a breakdown, the remote monitoring apparatus 200 generates a corresponding alarm signal. However, it is not intended to limit the present invention, and people skilled in the art can set a corresponding condition for generating an alarm signal according to actual demands without departing from the spirit or scope of the present invention.

It is known from the above embodiments of the present invention that applying the present invention has following advantages. The embodiments of the present invention provide a rack server system, so as to solve the problem that a large number of fans need to be disposed because heat dissipation control mechanisms of a rack server cannot be unified and the problem that it is difficult to perform uniform management and control when a new heat dissipation apparatus is added.

Although the present invention has been disclosed with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A rack server system, comprising:
a plurality of servers, each of which comprises a sensor for providing temperature information of each of the servers;
a plurality of cooling modules;
a power supply device comprising a plurality of power supply modules, wherein each of the power supply modules is used to provide a constant power; and
a monitoring management module communicatively connected with the servers and the cooling modules, wherein the monitoring management module comprises:
a processor;
a management network switch for providing a management network to connect the processor with each of the servers; and
a peripheral control interface for connecting the cooling modules and the power supply device to the processor;
wherein, through the management network, the processor obtains a power consumption from each of the servers and obtains the temperature information from the sensor of each of the servers, the processor decides to turn on some of the power supply modules through the peripheral control interface based on a total power consumption of the servers so that the power supply device provides a dynamic power, and the processor controls the cooling modules through the peripheral control interface based on the obtained temperature information.

2. The rack server system of claim 1, wherein each of the cooling modules is a fan or a water-cooled apparatus.

3. The rack server system of claim 2, wherein the monitoring management module further comprises a memory which is used to store a comparison table of a temperature and a fan rotation speed, and the processor looks up in the comparison table of the temperature and the fan rotation speed based on the obtained temperature information to obtain a fan rotation speed value and then adjusts a rotation speed of the fans through the peripheral control interface based on the fan rotation speed value.

4. The rack server system of claim 3, wherein the processor controls the rotation speed of the fans based on the fan rotation speed value so that the rotation speed of the fans is not lower than the fan rotation speed value.

5. The rack server system of claim 1, wherein the monitoring management module further comprises:
a system network switch communicatively connected with an external Ethernet and for providing a system network; and
a remote monitoring apparatus, wherein the processor and each of the servers are connected to the remote monitoring apparatus through the system network.

6. The rack server system of claim 5, wherein the remote monitoring apparatus is communicatively connected with the processor through the system network to obtain and display the temperature information and the power consumption of each of the servers, a turn-on or turn-off state of the power supply modules of the power supply device, and the rotation speed value of each of the fans.

7. The rack server system of claim 5, wherein the remote monitoring apparatus is used to set an upper limit of the power consumption of each of the servers.

8. The rack server system of claim 5, wherein, when knowing through the system network that any one of the servers, the power supply modules or the fans has a breakdown, the remote monitoring apparatus generates a corresponding alarm signal.
